(19) United States
(12) Patent Application Publication
(10) Pub. No.: US 2026/0269347 A1
(43) Pub. Date: Sep. 10, 2026

(54) POUCH FILM FOR SECONDARY BATTERY, METHOD FOR MANUFACTURING POUCH FILM, AND POUCH-TYPE SECONDARY BATTERY

(71) Applicant: SK On Co., Ltd., Seoul (KR)

(72) Inventors: Jae Hui PARK, Daejeon (KR); Hyun Ji KIM, Daejeon (KR)

(21) Appl. No.: 19/561,564

(22) Filed: Mar. 10, 2026

(30) Foreign Application Priority Data
Mar. 10, 2025 (KR) 10-2025-0030715

(51) Int. Cl. H01M 10/48; H01M 10/052; H01M 50/105; H01M 50/119; H01M 50/121; H01M 50/129

(52) U.S. Cl. CPC H01M 10/488; H01M 10/052; H01M 50/105; H01M 50/119; H01M 50/121; H01M 50/129

(57) ABSTRACT

According to an embodiment of the present disclosure, a pouch film for a secondary battery may include an opaque portion disposed at both edges of the pouch film in a length direction; and a transparent portion disposed between the opaque portions, wherein a length of the transparent portion is 20% or more and less than 70% of a total length of the pouch film.

### CROSS-REFERENCE TO RELATED APPLICATIONS

This patent document claims the priority and benefits of Korean Patent Application No. 10-2025-0030715, filed on Mar. 10, 2025, the disclosure of which is incorporated herein by reference in its entirety.

### TECHNICAL FIELD

The present disclosure relates to a pouch film for a secondary battery, a method for manufacturing a pouch film, and a pouch-type secondary battery.

### BACKGROUND

Recently, research into electric vehicles (EVs) which may replace fossil fuel-based vehicles, which may be one of the main causes of air pollution, has been actively conducted, and demand for a secondary battery having a high discharge voltage and stable output as a power source for such electric vehicles has increased.

A secondary battery may be classified as a pouch-type secondary battery, a cylindrical secondary battery, a prismatic secondary battery, or the like, depending on the type of exterior material, and among the secondary batteries, a pouch-type secondary battery in which an electrode assembly is embedded in a accommodation portion of a pouch case may have a low manufacturing cost and a high-capacity battery pack may be easily formed by connecting a plurality of unit cells in series and/or in parallel, such that research and development thereof have been actively conducted. Accordingly, research into pouches which may be cost-effective, ensure safety, and may be highly practical in the manufacture and use of a secondary battery may be necessary.

### SUMMARY

The present disclosure can be implemented in some embodiments to provide a pouch film which may be economical and may ensure stability.

The present disclosure can be implemented in some embodiments to provide a pouch film allowing for inspection of the interior of a secondary battery.

The present disclosure can be implemented in some embodiments to provide a pouch-type secondary battery which may be economical and ensure stability.

The present disclosure can be implemented in some embodiments to provide a pouch-type secondary battery allowing for inspection of the interior of a secondary battery.

In some embodiments of the present disclosure, a pouch film for a secondary battery includes opaque portions disposed at both edges of the pouch film in a length direction; and a transparent portion disposed between the opaque portions, wherein a length of the transparent portion may be at least 20% and less than 70% of a total length of the pouch film.

Each of the opaque portion and the transparent portion may include an inner resin layer and an outer resin layer.

The inner resin layer includes at least one selected from a group consisting of polypropylene, acid-modified polypropylene, polyethylene, and polycarbonate.

The outer resin layer may include at least one selected from a group consisting of polyethylene terephthalate, nylon, polyethylene naphthalate, and polyurethane.

The opaque portion may include a metal layer.

The opaque portion may further include a metal layer disposed between the inner resin layer and the outer resin layer.

The metal layer may include at least one selected from a group consisting of aluminum (Al), iron (Fe), chromium (Cr), nickel (Ni), copper (Cu), silver (Ag), platinum (Pt), and alloys thereof.

A thickness ratio of the outer resin layer to the metal layer included in the opaque portion may be 1:2 to 1:1.

The transparent portion may not include a metal layer.

The transparent portion may have a light transmittance of 85% or more.

A thickness ratio of the outer resin layer included in the opaque portion to the outer resin layer included in the transparent portion may be 3:10 to 4:7.

A method for manufacturing a pouch film for a secondary battery including opaque portions disposed at both edges of the pouch film in a length direction; and a transparent portion disposed between the opaque portions, wherein a length of the transparent portion may be 20% or more and less than 70% of a total length of the pouch film.

The method may further include forming an outer resin layer; laminating a metal layer at both edges of the outer resin layer in a length direction; and laminating an inner resin layer on the outer resin layer and the metal layer.

In the laminating the metal layer, a length of a portion of the outer resin layer in which the metal layer is not laminated may be 20% or more and less than 70% of a total length of the outer resin layer.

The lamination may be performed by at least one method selected from a group consisting of dry lamination, extrusion lamination, heat sealing, adhesive lamination, and compression lamination.

A pouch-type secondary battery, comprising: an electrode assembly; and a pouch exterior material accommodating the electrode assembly, wherein the pouch exterior material includes an opaque portion disposed at both ends of the pouch exterior material in a length direction; and a transparent portion disposed between the opaque portions, wherein a length of the transparent portion may be 20% or more and less than 70% of a total length of the pouch exterior material.

The pouch exterior material may include an accommodation portion accommodating the electrode assembly and a sealing portion sealing an external surface of the accommodation portion.

A length (a) of a portion in which the accommodation portion and the opaque portion overlap each other may be greater than or equal to a depth (b) of the accommodation portion.

A length (c) of the sealing portion may be at least 1.5 times the depth (b) of the accommodation portion.

According to an embodiment of the present disclosure, the manufacturing costs of a pouch film may be reduced.

According to an embodiment of the present disclosure, the stability of a pouch film may be secured.

According to an embodiment of the present disclosure, a pouch film allowing inspection of the interior of a secondary battery may be provided.

According to an embodiment of the present disclosure, the manufacturing costs of a pouch-type secondary battery may be reduced.

According to an embodiment of the present disclosure, the stability of a pouch-type secondary battery may be ensured.

According to an embodiment of the present disclosure, a pouch-type secondary battery allowing inspection of the interior thereof may be provided.

### BRIEF DESCRIPTION OF DRAWINGS

FIG. 1 is a plan diagram illustrating a pouch film according to an embodiment of the present disclosure, viewed from above.

FIG. 2 is a cross-sectional diagram illustrating a pouch film according to an embodiment of the present disclosure.

FIG. 3 is a cross-sectional diagram illustrating a process of laminating a pouch film according to an embodiment of the present disclosure.

FIG. 4 is a plan diagram illustrating a pouch-type secondary battery according to an embodiment of the present disclosure, viewed from above.

FIG. 5 is a plan diagram illustrating a pouch-type secondary battery according to an embodiment of the present disclosure, viewed from the side.

### DETAILED DESCRIPTION

Features of the present disclosure disclosed in this patent document are described by example embodiments with reference to the accompanying drawings.

Hereinafter, embodiments of the present disclosure will be described in detail with reference to the accompanying drawings. However, embodiments of the present disclosure may be modified in various forms, and the scope thereof is not limited to the embodiments described below. Further, the subject matter disclosed herein may be applied to the components of the embodiments described below and the entirety or a portion of the respective embodiments may be combined to allow various modifications.

### Pouch Film for Secondary Battery

A pouch film 100 for a secondary battery according to an embodiment of the present disclosure may include an opaque portion 11 disposed at both edges in the length direction of the pouch film and a transparent portion 21 disposed between the opaque portions, and the length of the transparent portion may be 20% or more and less than 70% based on the total length of the pouch film.

The pouch film may include the opaque portions disposed at both edges and the transparent portion disposed between the opaque portions. Accordingly, without disassembling the pouch-type secondary battery, the state of the electrodes and electrolyte in the battery may be readily observed and evaluated through the transparent portion. In addition, by manufacturing the transparent portion with relatively lower costs than the opaque portions, the manufacturing cost of the pouch film may be reduced. Furthermore, the length of the transparent portion may be adjusted to 20% or more and less than 70% of the overall length of the pouch film, thereby ensuring ease of internal observation and securing the mechanical stability of vulnerable regions of the pouch exterior material (for example, the corner portions of a accommodation portion formed to accommodate an electrode assembly) during manufacturing of the pouch-type secondary battery.

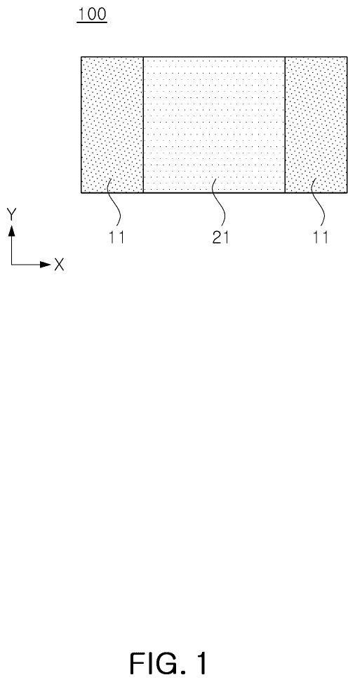

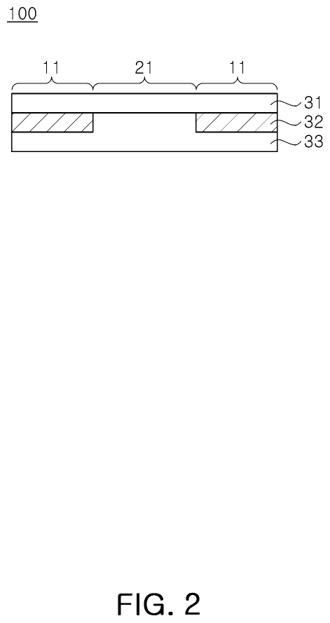

Hereinafter, the pouch film will be described in greater detail with reference to FIGS. 1 and 2.

FIG. 1 is a plan diagram illustrating a pouch film according to an embodiment of the present disclosure, viewed from above.

The pouch film may include the opaque regions disposed at both edges in the length direction of the pouch film and the transparent region disposed between the opaque regions. The length direction of the pouch film may be indicated as the X-axis direction in FIG. 1, and may refer to the direction in which an electrode tab (not illustrated) is connected during manufacturing of a pouch-type secondary battery. Hereinafter, in the description of the components of the pouch film, the term “length” may refer to a length measured in the length direction of the pouch film. The region between the opaque regions in which the transparent region is disposed may refer to the region of the pouch film other than the opaque regions.

The length of the transparent portion may be 20% or more and less than 70% based on the total length of the pouch film. For example, the length of the transparent portion may be 30% or more and less than 60% of the total length of the pouch film, or 35% or more and 56% or less of the total length of the pouch film.

When the length of the transparent portion is less than 20% based on the total length of the pouch film, the area of the transparent portion disposed on the pouch film may be relatively small, and such that it may be difficult to observe the interior of the pouch-type secondary battery. In addition, it may be difficult to reduce the manufacturing cost of the pouch film. When the length of the transparent portion is 70% or more based on the total length of the pouch film, it may be difficult to secure the mechanical stability of a vulnerable portion of the pouch exterior material during the manufacturing of the pouch-type secondary battery.

FIG. 2 is a cross-sectional diagram illustrating a pouch film according to an embodiment of the present disclosure.

The opaque portion 11 and the transparent portion 21 may include an inner resin layer 31 and an outer resin layer 33, respectively. The inner resin layer and the outer resin layer may be transparent, and the specific degree of transparency is not limited as long as the interior may be readily observed through the resin layers. For example, the light transmittance of the inner resin layer and the outer resin layer may be 85% or more. More specifically, the light transmittance of the inner resin layer and the outer resin layer may be 90% or more. The method for measuring light transmittance is not limited. For example, the light transmittance may be measured using a visible-light transmittance meter at a wavelength of 550 nm.

The inner resin layer may be disposed on an inner surface of the pouch exterior material on which an electrode assembly is accommodated during the manufacturing of a pouch-type secondary battery. The material of the inner resin layer is not particularly limited so long as the material has excellent waterproofness, electrolyte resistance, and heat resistance, and is easily formed and sealed. In an embodiment, the inner resin layer may include at least one selected from the group consisting of polypropylene, acid-modified polypropylene, polyethylene, and polycarbonate.

The specific form of the inner resin layer is not limited. For example, the inner resin layer may be formed by laminating an acid-modified polypropylene (PPa) layer, to which metal adhesion may be easily performed, onto a sealant layer which may be easily sealed.

The outer resin layer may be disposed on the external surface of the pouch exterior material in which the electrode assembly is accommodated during the manufacturing of a pouch-type secondary battery. The material of the outer resin layer is not particularly limited, as long as the material has excellent waterproofing, insulating properties, heat resistance, surface rigidity, and is easily molded. In an embodiment, the outer resin layer may include at least one material selected from the group consisting of polyethylene terephthalate, nylon, polyethylene naphthalate, and polyurethane.

The specific form of the external resin layer is not limited. For example, the external resin layer may be formed by bonding a first external resin layer having excellent heat resistance and easily molded, and a second external resin layer having excellent surface rigidity by an adhesive layer.

In an embodiment, the opaque portion 11 may include a metal layer 32. The opaque portion may obtain mechanical strength by including the metal layer. Accordingly, by improving the mechanical strength of the pouch film, the mechanical stability of vulnerable portions of the pouch exterior material may be ensured during the manufacturing of the pouch-type secondary battery.

In an embodiment, the opaque portion 11 may further include a metal layer 32 between the inner resin layer 31 and the outer resin layer 33. As the metal layer is disposed between the inner resin layer 31 and the outer resin layer 33, corrosion and mechanical damage of the metal layer may be prevented, thereby ensuring the stability of the pouch film. The material of the metal layer is not particularly limited as long as the material has excellent mechanical strength, water resistance, and is readily formable. In an embodiment, the metal layer may include at least one metal selected from the group consisting of aluminum (Al), iron (Fe), chromium (Cr), nickel (Ni), copper (Cu), silver (Ag), platinum (Pt), or alloys thereof.

In an embodiment, a thickness ratio of a thickness of the outer resin layer to a thickness of the metal layer included in the opaque portion may be 1:2 to 1:1. When the thickness ratio of the outer resin layer to the metal layer included in the opaque portion is less than 0.5, the thickness of the outer resin layer may not be sufficiently ensured, such that insulation may not be sufficiently ensured, or it may be difficult to prevent damage to the metal layer. When the thickness ratio of the outer resin layer to the metal layer included in the opaque portion exceeds 1, the thickness of the metal layer may not be sufficiently ensured, such that it may be difficult to secure the mechanical stability of the vulnerable portion of the pouch exterior material during manufacturing of the pouch-type secondary battery.

In an embodiment, the transparent portion may not include a metal layer. The transparent portion may not include an opaque metal layer and may include only the outer resin layer and the inner resin layer, thereby easily performing internal observation. In addition, by using a smaller amount of the metal layer, which is relatively costly to manufacture, when manufacturing the pouch film, the manufacturing cost of the pouch film may be reduced.

The transparency of the transparent portion is not particularly limited as long as the interior may be easily observed through the transparent portion. For example, the light transmittance of the transparent portion may be 85% or greater. More specifically, the light transmittance of the transparent portion may be 90% or greater. The method of measuring the light transmittance is s not limited. For example, the light transmittance may be measured using a visible-light transmittance meter at a wavelength of 550 nm.

The thickness of the outer resin layer included in the opaque portion may be less than the thickness of the outer resin layer included in the transparent portion. Therefore, even when the opaque portion further includes a metal layer between the outer resin layer and the inner resin layer and the transparent portion does not include the metal layer, the overall thickness of the pouch film may be constant.

In an embodiment, the thickness ratio of a thickness of the outer resin layer included in the opaque portion to a thickness of the outer resin layer included in the transparent portion may be 3:10 to 4:7. When the thickness ratio of the outer resin layer included in the opaque portion to the outer resin layer included in the transparent portion is less than 0.3, the thickness of the outer resin layer in the opaque portion may not be sufficiently secured, such that it may be difficult to ensure insulation or to prevent damage to the metal layer. When the thickness ratio of the outer resin layer included in the opaque portion to the thickness of the outer resin layer included in the transparent portion exceeds 0.57, a thickness of the metal layer laminated on the outer resin layer of the opaque portion may not be sufficiently secured, such that it may be difficult to ensure the mechanical stability of vulnerable portion of the pouch exterior during manufacturing of the pouch-type secondary battery.

### Pouch Film Manufacturing Method

A method for manufacturing a pouch film for a secondary battery according to an embodiment of the present disclosure may be a method for manufacturing a pouch film for a secondary battery including an opaque portion arranged at both edges of the pouch film in the length direction; and a transparent portion arranged between the opaque portions, and the length of the transparent portion may be 20% or more and less than 70% of the total length of the pouch film.

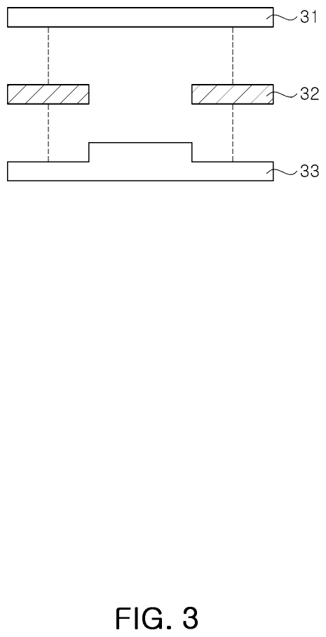

FIG. 3 is a cross-sectional diagram illustrating a process of laminating a pouch film according to an embodiment of the present disclosure.

In an embodiment, the method for manufacturing a pouch film may include forming an outer resin layer; laminating a metal layer at both edges of the outer resin layer in the length direction of the outer resin layer; and laminating an inner resin layer on the outer resin layer and the metal layer. By laminating the metal layer only at both edges of the outer resin layer after the outer resin layer is formed, an opaque portion including the metal layer and a transparent portion not including the metal layer may be formed. Accordingly, the mechanical stability of the opaque portion including the metal layer may be secured, and the ease of internal observation of the transparent portion not including the metal layer may be secured.

In an embodiment, in the laminating the metal layer, the length of the region of the outer resin layer in which the metal layer is not laminated may be 20% or more and less than 70% of the total length of the outer resin layer. By adjusting the length of the region in which the metal layer is not deposited to within the above range, both the mechanical strength of the pouch film and the ease of internal inspection may be secured. When the length of the region in which the metal layer is not laminated is less than 20% based on the total length of the outer resin layer, the area of the transparent portion may not be sufficiently secured, such that it may be difficult to perform internal inspection of the pouch-type secondary battery and to reduce manufacturing costs. When the length of the region in which the metal layer is not laminated is 70% or more based on the total length of the outer resin layer, the area of the opaque portion including the metal layer is not sufficiently secured, such that it may be difficult to ensure the mechanical stability of a vulnerable portion of the pouch exterior material.

The method of laminating the metal layer or the method of laminating the inner resin layer is not particularly limited. In an embodiment, the lamination may be carried out by at least one method selected from the group consisting of dry lamination, extrusion lamination, thermal bonding, adhesive lamination, and compression lamination.

In the method for manufacturing the pouch film, the components (for example, the outer resin layer, the inner resin layer, the metal layer, and the specific materials, shapes, thicknesses, and properties thereof) included in the transparent portion and the opaque portion may be the same as those of the above-described pouch film, and thus a detailed description thereof will not be provided.

### Pouch-Type Secondary Battery

A pouch-type secondary battery 200 according to an embodiment of the present disclosure may include an electrode assembly and a pouch exterior material accommodating the electrode assembly, and the pouch exterior material may include opaque portions 12 disposed at both edges in the length direction of the pouch exterior material and a transparent portion 22 disposed between the opaque portions, and the length of the transparent portion may be 20% or more and less than 70% based on the total length of the pouch exterior material.

The pouch-type secondary battery may include opaque portions disposed at both edges in the length direction of the pouch exterior material and a transparent portion disposed between the opaque portions. Accordingly, the state of electrodes, electrolyte, or the like, in the battery may be easily observed and evaluated through the transparent portion without disassembling the pouch-type secondary battery. In addition, by manufacturing the transparent portion with less cost than the opaque portions, the manufacturing cost of the pouch-type secondary battery may be reduced. Furthermore, by adjusting the length of the transparent portion to be 20% or more and less than 70% based on the total length of the pouch exterior material, ease of internal observation may be ensured while securing the mechanical stability of a vulnerable portion (for example, corner portions of a receiving section molded to accommodate the electrode assembly) of the pouch exterior material.

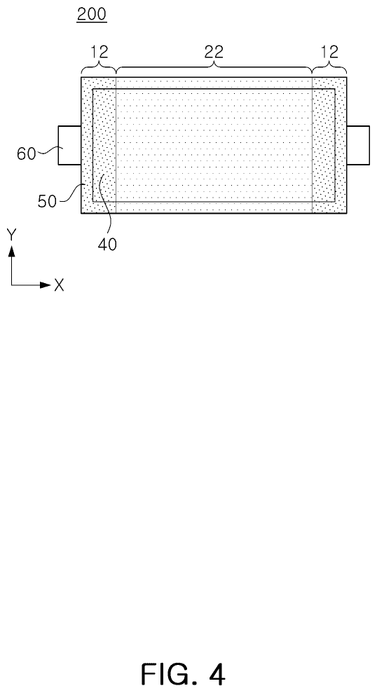

FIG. 4 is a plan diagram illustrating a pouch-type secondary battery according to an embodiment of the present disclosure, viewed from above.

The pouch exterior material may include opaque portions disposed at both edges in the length direction of the pouch exterior material and a transparent portion disposed between the opaque portions. The length direction of the pouch exterior material is indicated as the X-axis direction in FIG. 4, and may refer to the direction in which the electrode tab 60 is connected in the pouch-type secondary battery. Hereinafter, in the description of components of the pouch exterior material, the term “length” may indicate a length measured in the length direction of the pouch exterior material. The region between the opaque portions, in which the transparent portion is disposed, may refer to the region of the pouch exterior material other than the regions in which the opaque portions are disposed.

The length of the transparent portion 22 may be 20% or more and less than 70% based on the total length of the pouch exterior material. For example, the length of the transparent portion 22 may be 25% or more and less than 60%, or 30% or more and 50% or less, based on the total length of the pouch exterior material.

When the length of the transparent portion is less than 20% of the total length of the pouch exterior material, the area of the transparent portion disposed in the pouch exterior material may be relatively small, such that it may be difficult to observe the interior of the pouch-type secondary battery. In addition, it may be difficult to reduce the manufacturing cost of the pouch-type secondary battery. When the length of the transparent portion is 70% or more, it may be difficult to secure the mechanical stability of a vulnerable portion of the pouch exterior material during the manufacturing of the pouch-type secondary battery.

In the pouch-type secondary battery 200, the components (for example, the outer resin layer, the inner resin layer, the metal layer, and specific materials, shapes, thicknesses, properties thereof, or the like) included in the transparent portion 22 and the opaque portion 12 may be the same as those of the pouch film 100 described above, and thus a detailed description thereof will not be provided.

In an embodiment, the pouch exterior material may include an accommodation portion 40 in which the electrode assembly is accommodated, and a sealing portion 50 sealing an external surface of the accommodation portion.

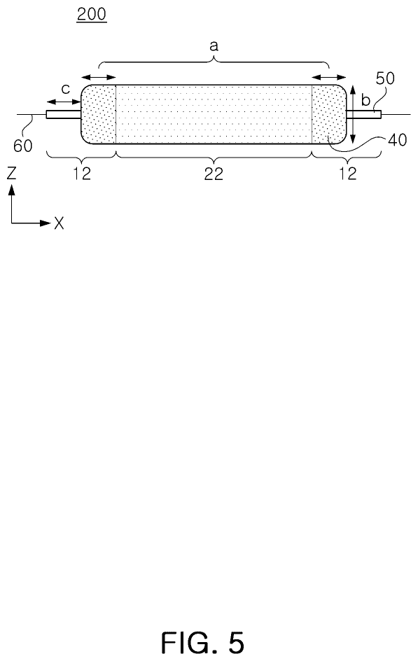

FIG. 5 is a plan diagram illustrating a pouch-type secondary battery according to an embodiment of the present disclosure.

As long as the accommodation portion is molded to accommodate an electrode assembly, the shape thereof is not limited. For example, in FIG. 5 the accommodation portion may have the same depth in the vertical direction with respect to the sealing portion, but the depth in the vertical direction with respect to the sealing portion may be different, and no depth may be formed in one direction, formed as a cover portion.

In an embodiment, the length (a) of the portion in which the accommodation portion and the opaque portion overlap each other may be equal to or greater than the depth (b) of the accommodation portion. The length (a) of the portion in which the accommodation portion and the opaque portion overlap each other may refer to the sum of the lengths of the portion in which the opaque portions on both sides overlap the accommodation portion based on the length direction of the pouch exterior material (X-axis direction in FIG. 4). The depth (b) of the accommodation portion may refer to the overall depth of the accommodation portion molded in the thickness direction of the pouch exterior material (Z-axis direction in FIG. 4) to accommodate the electrode assembly. When the length (a) of the overlapping portion is less t than the depth (b) of the accommodation portion, the pouch metal layer may be excessively stretched during the pouch molding process, such that it may be difficult to ensure the mechanical stability of a vulnerable portion of the pouch exterior material.

In an embodiment, the length (c) of the sealing portion may be 1.5 times the depth (b) of the accommodation portion or more. The length (c) of the sealing portion may refer to the length of one of the sealing portions disposed on both sides in the length direction of the pouch exterior material. When the length (c) of the sealing portion is less than 1.5 times the depth (b) of the accommodation portion, the pouch metal layer may be excessively elongated during the process of forming the pouch, such that it may be difficult to secure the mechanical stability of a vulnerable portion of the pouch exterior material.

The structure of the electrode assembly is not particularly limited. For example, the electrode assembly may have a structure including one or more unit cells, and the unit cells may include a positive electrode and a negative electrode.

Each of the positive electrode and the negative electrode may include a current collector and a composite layer formed on at least one surface of the current collector. The types and thicknesses of the current collector of the positive electrode and the current collector of the negative electrode are not particularly limited. For example, aluminum foil (Al foil) may be used as the current collector of the positive electrode, and copper foil (Cu foil) may be used as the current collector of the negative electrode. In addition, the thicknesses of the current collector of the positive electrode and the current collector of the negative electrode may be, for example, 10 to 50 μm.

The composite layer of the positive electrode and the composite layer of the negative electrode may be configured as an active layer including an active material substantially participating in the electrochemical reaction of the secondary battery, and the composite layer of the positive electrode may include a positive electrode active material, and the composite layer of the negative electrode may include a negative electrode active material.

The positive electrode active material is not particularly limited, and may include a compound which may reversibly intercalate and deintercalate lithium ions.

According to embodiments, the positive electrode active material may include a lithium-nickel metal oxide. The lithium-nickel metal oxide may further include at least one of cobalt (Co), manganese (Mn), or aluminum (Al).

In some embodiments, the positive electrode active material or the lithium-nickel metal oxide may include a layered or crystalline structure represented by Formula 1.

LiₓNiₐM_{b}O_{2+z} [Formula 1]

In Formula 1, x may be 0.9 to 1.2, a may be 0.95≤x≤1.2, 0.6≤a≤0.99, 0.01≤b≤0.4, −0.5≤z≤0.1. As described above, M may include Co, Mn, and/or Al.

The chemical structure represented by Formula 1 indicates a bonding relationship included within a layered structure or a crystal structure of a positive electrode active material and does not exclude the presence of additional elements. For example, M may include Co and/or Mn, and Co and/or Mn may be provided as main active elements of the positive electrode active material together with Ni. Formula 1 is provided to represent the bonding relationship among the main active elements and should be understood to encompass the introduction and substitution of additional elements.

In an embodiment, auxiliary elements added to the main active element and enhancing the chemical stability of the positive electrode active material or the layered and/or crystal structure may be further included. The auxiliary elements may be co-incorporated into the layered and/or crystal structure and may form bonds, and, in this case, the elements may be understood as being included in the chemical structural range represented by Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. The auxiliary element may, for example, act as an auxiliary active element such as Al, which may, together with Co or Mn, contribute to the capacity and/or output activity of the positive electrode active material.

For example, the positive electrode active material or the lithium-nickel metal oxide may include a layered structure or a crystalline structure represented by Formula 1-1.

LiₓNiₐM1_{b1}M2_{b2}O_{2+z} [Formula 1-1]

In Formula 1-1, M1 may include Co, Mn, and/or Al. M2 may include the aforementioned auxiliary element. In Formula 1-1, 0.9≤x≤1.2, 0.6≤a≤0.99, 0.01≤b1+b2≤0.4, and −0.5≤z≤0.1.

The positive electrode active material may further include a coating element or a doping element. For example, elements substantially the same as or similar to the aforementioned auxiliary elements may be used as a coating element or a doping element. For example, one of the aforementioned elements alone, or two or more of the aforementioned elements in combination, may be used as a coating element or a doping element.

The coating element or the doping element may be present on the surface of the lithium-nickel metal oxide particles, or may penetrate through the surface of the lithium-nickel metal particles and may be incorporated into the composite oxide bonding structure represented by Formula 1 or Formula 1-1.

The positive electrode active material may include a nickel-cobalt-manganese (NCM)-based lithium oxide. In this case, an NCM-based lithium oxide having an increased nickel content may be used.

Ni may be provided as a transition metal associated with the power output and capacity of a lithium secondary battery. Therefore, as described above, by employing a high-Ni composition in the positive electrode active material, a high-capacity positive electrode and a high-capacity lithium secondary battery may be provided.

However, as the Ni content increases, the long-term storage stability and lifetime stability of the positive electrode or the secondary battery may be relatively degraded, and side reactions with the electrolyte may increase. However, according to embodiments, by including Co, electrical conductivity may be maintained, and lifespan stability and capacity retention properties may improve.

The Ni content (for example, the mole fraction of nickel in the total moles of nickel, cobalt, and manganese) in the NCM-based lithium oxide may be 0.6 or greater, 0.7 or greater, or 0.8 or greater. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the positive electrode active material may include a lithium cobalt oxide-based active material, a lithium manganese oxide-based active material, a lithium nickel oxide-based active material, or a lithium iron phosphate (LFP) active material (e.g., LiFePO₄).

In some embodiments, the positive electrode active material may include, for example, a Mn-rich active material having a chemical or crystalline structure represented by Formula 2, a Li-rich layered oxide (LLO)/over-lithiated oxide (OLO) active material, and a Co-less active material.

p[Li₂MnO₃]·(1−p)[Li_{q}JO₂] [Formula 2]

In Formula 2, 0<p<1, 0.9≤q≤1.2, and J may include at least one element selected from the group consisting of Mn, Ni, Co, Fe, Cr, V, Cu, Zn, Ti, Al, Mg, and B.

The negative electrode active material is not particularly limited and may include a material adsorbing and desorbing lithium ions. For example, as the negative electrode active material, a carbon-based material such as crystalline carbon, amorphous carbon, a carbon composite, or carbon fiber; lithium metal; a lithium alloy; a silicon (Si)-containing material; or a tin (Sn)-containing material may be used.

Examples of amorphous carbon may include hard carbon, carbon, coke, mesocarbon microbeads (MCMB), mesophase soft pitch-based carbon fibers (MPCF), or the like.

Examples of crystalline carbon may include graphitic carbons such as natural graphite, artificial graphite, graphitized coke, graphitized MCMB, and graphitized MPCF.

The lithium metal may be pure lithium metal or lithium metal having a protective layer to suppress dendrite growth. In an embodiment, a lithium metal-containing layer deposited or coated on the current collector of the negative electrode may be used as a negative electrode active material layer. In an embodiment, a lithium thin film layer may be used as a negative electrode active material layer.

Examples of elements included in the lithium alloy may include aluminum, zinc, bismuth, cadmium, antimony, silicon, lead, tin, gallium, or indium.

The silicon-containing material may provide increased capacity properties. The silicon-containing material may include Si, SiOx(0<x<2), carbon-coated SiOx(0<x<2), metal-doped SiOx(0<x<2), silicon-carbon composites, or the like. The metal may include lithium and/or magnesium, and the metal-doped SiOx(0<x<2) may include metal silicate.

Each of the positive electrode composite layer and the negative electrode composite layer may a further include conductive material. The conductive material is not particularly limited and may be at least one selected from among graphite such as natural graphite or artificial graphite; carbon-based materials such as carbon black, acetylene black, Ketjen black, channel black, furnace black, lamp black, thermal black, carbon fibers, and carbon nanotubes (CNT); metal powders or metal fibers such as copper, nickel, aluminum, and silver; conductive whiskers such as zinc oxide and potassium titanate; conductive metal oxides such as titanium oxide; and conductive polymers such as polyphenylene derivatives. When the positive electrode composite layer further includes a conductive material, the content thereof may be, for example, 0.1 to 5 weight % based on the total weight of the positive electrode composite layer. When the negative electrode composite layer further includes conductive material, the content thereof may be, for example, 0.1 to 5 weight based on the total weight of the negative electrode composite layer.

Each of the positive electrode composite layer and the negative electrode composite layer may further include a binder. The binder is not particularly limited. The binder included in the positive electrode composite layer may be, for example, at least one selected from among polyvinylidene fluoride (PVDF), polyvinyl (PVA), polyvinylpyrrolidone (PVP), alcohol carboxymethylcellulose (CMC), ethylcellulose, an acrylic resin, styrene-butadiene rubber (SBR), and polytetrafluoroethylene (PTFE). In addition, the binder included in the negative electrode composite layer may be, for example, at least one selected from among a rubber-based binder such as styrene-butadiene rubber (SBR), a fluorine-based rubber, ethylene propylene rubber, butyl acrylate rubber, butadiene rubber, isoprene rubber, acrylonitrile rubber, acrylic rubber, and silane-based rubber; and a cellulose-based binder such as carboxymethylcellulose (CMC), hydroxypropyl methylcellulose, methylcellulose, or an alkali metal salt (Na, K, or Li) thereof. When the positive electrode composite layer further includes a binder, the content thereof may be, for example, 0.1 to 5 weight % based on the total weight of the positive electrode composite layer. In addition, when the negative electrode composite layer further includes a binder, the content thereof may be, for example, 0.1 to 5 weight % based on the total weight of the negative electrode composite layer.

The unit cell according to the above-described embodiments may not include a separator between the positive electrode and the negative electrode, or may further include a separator. When the unit cell further includes a separator, the separator may be a polyolefin-based polymer separator (e.g., polyethylene, polypropylene), glass fiber, polyester, polytetrafluoroethylene, or a combination thereof, and may be in the form of a nonwoven fabric or a woven fabric. In addition, the separator may be coated with a composition including a ceramic component to secure heat resistance or mechanical strength, and may be selectively configured as a single-layer or a multilayer structure. A separator having the above-described compounds or structures may be applied, but the separator is not limited thereto.

The unit cell included in the pouch-type secondary battery according to the above-described embodiments may further include a solid electrolyte. That is, the unit cell included in the pouch-type secondary battery may include a solid electrolyte without a separator between the positive electrode and the negative electrode. The solid electrolyte is not particularly limited and may, for example, be an oxide-based solid electrolyte, a sulfide-based solid electrolyte, or a polymer-based solid electrolyte.

When the pouch-type secondary battery according to the above-described embodiments does not further include a solid electrolyte, the secondary battery may be manufactured by accommodating a unit cell including the above-mentioned positive electrode and negative electrode in a pouch serving as a battery case and injecting an electrolyte.

The electrolyte may include an organic solvent and a lithium salt. The organic solvent may serve as a medium through which ions involved in electrochemical reactions of the battery may migrate, and may be selected from carbonate-based, ester-based, ether-based, ketone-based, alcohol-based, or aprotic solvents used alone or in combination; when two or more solvents are mixed, the mixing ratio thereof may be appropriately adjusted depending on the desired battery performance. The lithium salt may dissolve in the organic solvent and may serve as a source of lithium ions in the battery, enabling operation of a lithium secondary battery and facilitating movement of lithium ions between a positive electrode and a negative electrode. Known lithium salts may be used at concentrations suitable for the intended purpose thereof. The electrolyte may further include known solvents to improve charge and discharge characteristics, flame retardancy, or the like, and may include known additives.

### EMBODIMENT

Hereinafter, embodiments of the present disclosure will be further described with reference to specific experimental examples. The examples and comparative examples included the experimental examples are merely examples of the present disclosure and do not limit the appended claims, and it will be apparent to those skilled in the art that various changes and modifications to the embodiments may be made within the scope and spirit of the present disclosure, such modifications being intended to fall within the scope of the appended claims.

### 1. Preparation of Pouch Film

### (1) Embodiment 1

An outer resin layer of a PET/nylon pouch film of which both edges have a thickness of 30 μm and a central portion located between the edges has a thickness of 70 μm was formed by laminating a transparent polyethylene terephthalate (PET) resin and a nylon resin by passing the materials through rollers. The length of the 70 μm-thick portion was formed to be 35% of the total length of the outer resin layer.

Thereafter, the aluminum foil coated with the adhesive and the outer resin layer were passed together through a roller to laminate an aluminum metal layer. In this case, the metal layer was laminated to a thickness of 40 μm only at both edges of the outer resin layer, which has a thickness of 30 μm.

Thereafter, transparent polypropylene (PP) and acid-treated polypropylene (PPa) resins were extruded and the laminated body in which the outer resin layer and the metal layer were laminated was passed through a roller to laminate an 80 μm thick inner resin layer. Accordingly, a pouch film in which an opaque portion including an outer resin layer, a metal layer, and an inner resin layer was arranged at both edges, and a transparent portion including an outer resin layer and an inner resin layer was arranged between the opaque portions was manufactured.

### (2) Embodiment 2

A pouch film was manufactured in the same manner as in Embodiment 1, other than that a portion of the outer resin layer having a thickness of 70 μm was formed to have a length equal to 56% of the total length of the outer resin layer.

### (3) Comparative Example 1

A pouch film was manufactured in the same manner as in Embodiment 1, other than that a portion of the outer resin layer having a thickness of 70 μm was formed to have a length equal to 12% of the total length of the outer resin layer.

### (4) Comparative Example 2

A pouch film was manufactured in the same manner as in Embodiment 1, other than that the portion of the outer resin layer having a thickness of 70 μm was formed to have a length equal to 74% of the total length of the outer resin layer.

### (5) Comparative Example 3

A pouch film was manufactured in the same manner as in Embodiment 1, other than that a portion of the outer resin layer having a thickness of 70 μm was formed to have a length of 92% of the total length of the outer resin layer.

### Manufacturing a Pouch-Type Secondary Battery

The pouch film manufactured according to the Embodiments and Comparative Examples was formed into a pouch exterior using a pouch forming apparatus. In this case, a first accommodation portion and a second accommodation portion for accommodating the electrode assembly by covering the electrode assembly in the vertical direction were formed on the pouch outer material, and the total depth of the storage sections was 7.5 mm.

A negative electrode slurry including 95 wt % artificial graphite as a negative electrode active material was prepared, and the negative electrode slurry was applied to a copper foil (Cu-foil) having a thickness of 20 μm, dried at 120° C., and rolled to prepare a negative electrode having a thickness of 150 μm. A positive electrode slurry including 94 wt % of LiCoO₂ as a positive electrode active material was prepared, and the positive electrode slurry was applied to an aluminum foil (Al-foil) having a thickness of 20 μm, dried at 120° C., and rolled to prepare a positive electrode having a thickness of 150 μm. An electrode assembly was prepared by interposing a polyolefin separator between the positive electrode and the negative electrode prepared as described above.

Thereafter, the electrode assembly was accommodated in the pouch exterior material, and an electrolyte in which 1 M of LiPF₆ was dissolved in a solvent mixture of ethylene carbonate (EC) and diethyl carbonate (DEC) was injected. Thereafter, the external surface of the pouch housing was sealed to manufacture a pouch-type secondary battery. In this case, the length of the region in which the transparent portion was formed in the pouch-type secondary battery, based on the entire length of the pouch exterior material, is shown in Table 1 below.

### 3. Internal Observation and Evaluation of the Stability of the Secondary Battery

### (1) Internal Observation and Evaluation of the Secondary Battery

The states of the electrodes and the electrolyte inside the battery were observed through a transparent portion formed in the pouch exterior without disassembling the pouch-type secondary battery manufactured according to the above embodiments and comparative examples. For the internal observation, a 1000-lumen (lm) LED light was disposed perpendicular to the pouch-type secondary battery, and the distance between the light source and the sample was fixed at 30 centimeters (cm). In the internal observation results, a circle (o) indicates that internal states, such as the electrode surface and the remaining electrolyte, were readily observable, and a cross (x) indicates that the states were difficult to observe.

### (2) Tensile Strength Evaluation

The tensile strength of the pouch films manufactured according to the Embodiment and Comparative Examples was measured using an Instron universal testing machine (UTM), and the results are shown in Table 1 below.

### (3) Evaluation of Stability During High-Temperature Storage

The pouch-type secondary batteries prepared according to the above-described Embodiments and Comparative Examples were charged at a 1 C rate by CC-CV charging (4.2 V, 0.05 C cut-off) at room temperature and stored at 60° C. in an oven for 4 weeks. In this case, the presence or absence of cracks at the edge portion of the electrode assembly housing of the pouch outer material was recorded as “o” when no crack was found and “x” when a crack was found, as shown in Table 1.

TABLE 1

| | | Transparent | | | |
|---|---|---|---|---|---|
| | | Portion | | | |
| | Transparent | Length/ | | | |
| | Portion | Pouch | Secondary | | Stability |
| | Length/ | Exterior | Battery | | During |
| | Pouch Film | Material | Internal | Tensile | High- |
| | Length | Length | Observation | Strength | Temperature |
| | (%) | (%) | Result | (N/mm##8##9) | Storage |
| Embodiment 1 | 35 | 30 | ## | 79.5 | ## |
| Embodiment 2 | 56 | 50 | ## | 78.8 | ## |
| Comparative | 12 | 10 | ## | 80.2 | ## |
| Example 1 | | | | | |
| Comparative | 74 | 70 | ## | 76.4 | ## |
| Example 2 | | | | | |
| Comparative | 92 | 90 | ## | 75.6 | ## |
| Example 3 | | | | | |

Referring to Table 1, it was confirmed that Embodiment 1 and 2 in which the length of the transparent portion formed in the pouch film satisfied 20% or more and less than 70% of the total length of the pouch film, and the length of the transparent portion formed in the formed pouch outer material also satisfied 20% or more and less than 70% of the total length of the pouch outer material facilitated internal observation without disassembling the secondary battery, and had excellent tensile strength and stability during high-temperature storage.

On the other hand, in the case of Comparative Example 1 in which the length of the transparent portion formed on the pouch film was less than 20% of the total length of the pouch film, and the length of the transparent portion formed on the formed pouch outer material was less than 20% of the total length of the pouch outer material, it was confirmed that it was not easy to observe the inside of the secondary battery. This may be because the area of the transparent portion was not sufficiently secured, such that it may be difficult to observe the internal region of the secondary battery without disassembling the secondary battery.

In addition, in Comparative Examples 2 and 3, in which the length of the transparent portion formed in the pouch film was 70% or more of the total length of the pouch film and the length of the transparent portion formed in the formed pouch outer material was 70% or more of the total length of the pouch outer material, it was confirmed that the tensile strength and the stability during high-temperature storage were inferior. This may be because the area of the transparent portion not including aluminum (a metal having high mechanical strength) was excessively large, such that the mechanical stability of the pouch outer material was not sufficiently secured.

1. A pouch film for a secondary battery, comprising:
opaque portions disposed at both edges of the pouch film in a length direction; and
a transparent portion disposed between the opaque portions,
wherein a length of the transparent portion is at least 20% and less than 70% of a total length of the pouch film.

2. The pouch film of claim 1, wherein each of the opaque portion and the transparent portion includes an inner resin layer and an outer resin layer.

3. The pouch film of claim 2, wherein the inner resin layer includes at least one selected from a group consisting of polypropylene, acid-modified polypropylene, polyethylene, and polycarbonate.

4. The pouch film of claim 2, wherein the outer resin layer includes at least one selected from a group consisting of polyethylene terephthalate, nylon, polyethylene naphthalate, and polyurethane.

5. The pouch film of claim 1, wherein the opaque portion includes a metal layer.

6. The pouch film of claim 2, wherein the opaque portion further includes a metal layer disposed between the inner resin layer and the outer resin layer.

7. The pouch film of claim 5, wherein the metal layer includes at least one selected from a group consisting of aluminum (Al), iron (Fe), chromium (Cr), nickel (Ni), copper (Cu), silver (Ag), platinum (Pt), and alloys thereof.

8. The pouch film of claim 6, wherein the metal layer includes at least one selected from a group consisting of aluminum (Al), iron (Fe), chromium (Cr), nickel (Ni), copper (Cu), silver (Ag), platinum (Pt), and alloys thereof.

9. The pouch film of claim 6, wherein a thickness ratio of the outer resin layer to the metal layer included in the opaque portion is 1:2 to 1:1.

10. The pouch film of claim 1, wherein the transparent portion does not include a metal layer.

11. The pouch film of claim 1, wherein the transparent portion has a light transmittance of 85% or more.

12. The pouch film of claim 2, wherein a thickness ratio of the outer resin layer included in the opaque portion to the outer resin layer included in the transparent portion is 3:10 to 4:7.

13. A method for manufacturing a pouch film for a secondary battery including opaque portions disposed at both edges of the pouch film in a length direction; and a transparent portion disposed between the opaque portions,
wherein a length of the transparent portion is 20% or more and less than 70% of a total length of the pouch film.

14. The method of claim 13, further comprising:
forming an outer resin layer;
laminating a metal layer at both edges of the outer resin layer in a length direction; and
laminating an inner resin layer on the outer resin layer and the metal layer.

15. The method of claim 14, wherein in the laminating the metal layer, a length of a portion of the outer resin layer in which the metal layer is not laminated is 20% or more and less than 70% of a total length of the outer resin layer.

16. The method of claim 14, wherein the lamination is performed by at least one method selected from a group consisting of dry lamination, extrusion lamination, heat sealing, adhesive lamination, and compression lamination.

17. A pouch-type secondary battery, comprising:
an electrode assembly; and
a pouch exterior material accommodating the electrode assembly,
wherein the pouch exterior material includes an opaque portion disposed at both ends of the pouch exterior material in a length direction; and a transparent portion disposed between the opaque portions,
wherein a length of the transparent portion is 20% or more and less than 70% of a total length of the pouch exterior material.

18. The pouch-type secondary battery of claim 17, wherein the pouch exterior material includes an accommodation portion accommodating the electrode assembly and a sealing portion sealing an external surface of the accommodation portion.

19. The pouch-type secondary battery of claim 18, wherein a length (a) of a portion in which the accommodation portion and the opaque portion overlap each other is greater than or equal to a depth (b) of the accommodation portion.

20. The pouch-type secondary battery of claim 18, wherein a length (c) of the sealing portion is at least 1.5 times the depth (b) of the accommodation portion.
